(19) United States
(12) Patent Application Publication
(10) Pub. No.: US 2003/0023424 A1
(43) Pub. Date: Jan. 30, 2003

(54) Multimedia dictionary

(75) Inventor: Moshe Weiner, Kiryat Savionim Yehud (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: COMVERSE NETWORK SYSTEMS, LTD.

(21) Appl. No.: 09/916,326

(22) Filed: Jul. 30, 2001

(51) Int. Cl. G06F 17/20

(52) U.S. Cl. 704/8

(57) ABSTRACT

A system and method of translating information using, for example, a cellular telephone. A user inputs information into the system for translation into another language. The inputted information can be in any media type, format or language. The inputted information is stored in a MMS server and is accessed by a dictionary server. The dictionary server translates the inputted information into the media type, format and/or language that the user requests. The translated information is then sent to the user as a MMS message that is accessible to the user's cellular telephone.

### BACKGROUND OF THE INVENTION

1. Field of the Invention

The present invention relates generally to a multimedia messaging service (“MMS”) application and more specifically to using a multimedia service based application to provide translation or identification of items inputted in any media.

2. Description of Related Art

Multimedia messaging service is the ability to send and receive messages comprising a combination of text, sounds, images and video to MMS capable handsets and computers. MMS is a service that can be connected to all possible networks such as cellular networks, broadband networks, fixed line and Internet networks. As technology has evolved so has the needs of its users. Users, such as cellular telephone users, demand more out of their service. They require the ability to send and received such items as business cards, post cards and pictures.

Accordingly, MMS was developed to enhance the messaging based on the users' new demands. In the 3G cellular (3^{rd} generation of cellular communication specifications) architecture, MMS has been added. As stated above, this allows users of cellular telephone to send and receive messages exploiting the whole array of media types while also making it possible to support new content types as they become popular. MMS is well known in the telecommunications world and further information on how MMS works can be found at www.3gpp.org (also see the standards at ETSI, The European Telecommunications Standards Institute, 650, route des Lucioles, 06921 Sophia Antipolis, France, Tel:+33 4 92 94 42 00, Fax:+33 4 93 65 47 16, secretariat@etsi.fr).

The need for language translators is in great demand. There has always been the need and desire for people to travel the world and experience different cultures. Unfortunately, to communicate in these different cultures and countries, one needs to know the native language. Most of the time, it is not possible for a traveler to know every language of every country that is visited. Therefore, it has become important to have a device that can translate a foreign language in an efficient and convenient manner.

To meet the needs of people who travel to countries in which they do not speak the native language, industry has provided travelers with various translating books and devices that allow a traveler to input and/or look up a word in one language and see its equivalent in another language. For example, an American citizen visits France. The American wishes to say the word “you” but does not know the French equivalent. Prior to the present invention, the American would look up the word “you” in an English/French dictionary to learn that the French word for “you” is “vous.”

This process also works in the reverse. In the previous example, the American, while in France, might see the word “vous” on a sign. The American might then want to find out what the word “vous” means in English. By looking in a French/English dictionary, the American would learn that the French word “vous” is equivalent to the word “you” in English. These language dictionaries have even become electronic to encompass a larger vocabulary and to make their use easier on the user.

These dictionaries do not help when the user wants to know what someone speaking the language is saying. Using the example above, if a French person spoke to the American, the American would not be able to determine what was being said unless the French person wrote down everything that he said. This is one of many situations in which the current technology is limited.

### SUMMARY OF THE INVENTION

In view of the shortcomings and limitations of known language dictionaries, it is desirable to provide a messaging application that will give a user the ability to determine the meaning of any information regardless of the media or form that the information is in.

The present invention provides an application for MMS messaging which allows a user to enter information in any form, not merely written form, into a terminal such as a cellular telephone and receive a translation of the information needed.

The present invention solves the above-described problems and limitations by enabling a user of, for example, a cellular telephone to input into the telephone any type of information and by providing a service that will translate the inputted information into any language or form that is desired.

In a preferred embodiment of the present invention, a user can access a service using the user's cellular telephone. The user can then input information in any language or form to receive a translation. For example, an American can have a native French speaking person speak into the American's cellular telephone and the service will interpret and translate the spoken words into English for delivery to the cell telephone. The present invention is not limited to the form of the inputted or outputted information.

In another embodiment of the present invention, the user can use a personal computer or a fixed telephone line device (such as a desktop telephone) to gain access to the message translating service.

In yet another embodiment of the present invention, the user can have the information translated and sent as a message to another user in a preferred media.

Further objects, features and advantages of the invention will become apparent from a consideration of the following description and the appended claims when taken in connection with the accompanying drawings.

### BRIEF DESCRIPTION OF THE DRAWINGS

The above aspects of the present invention will become more apparent by describing in detail embodiments thereof with reference to the attached drawings, in which:

FIG. 1 is a block diagram illustrating the interrelationships between the components of the multimedia dictionary system of the present invention; and

FIGS. 2(a) and 2(b) show a flow chart of the process of the present invention.

FIG. 3 is a flowchart showing an example of a narrowing routine used to determine which object a user is interested in when the number of objects in a picture exceeds a threshold number.

### DETAILED DESCRIPTION OF THE PREFERRED EMBODIMENTS

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to one skilled in the art.

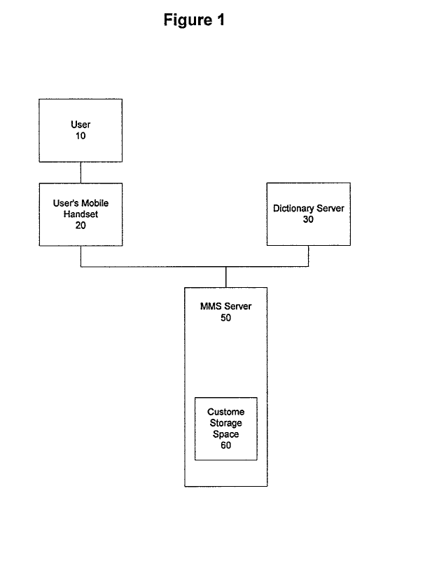

Referring to FIG. 1, a user 10 using a mobile handset 20 accesses the dictionary system of the present invention. In a preferred embodiment, the user 10 uses a mobile handset 20 but this should not be construed as a limitation. The user 10 may, for example, also gain access to the messaging system using other terminals such as, for example, a personal computer or a fixed telephone line device.

Once the user 10 gains access to the dictionary messaging system, the user 10 can enter the information that the user 10 would like to have translated. The information entered by the user 10 is not limited to one particular format. In fact, the user 10 can enter the information in any media format. In this art, there is a difference between “media” and “format.” Media refers to a way of saving or presenting content. For example, content can be a picture—thus a picture media and encoded in JPEG, GIF or other format. Likewise, audio and video would be a media type while MP3 and MPEG4 would be the format type. Accordingly, the user 10 can enter a picture media in a JPG format.

In order for the user 10 to transmit information (in any type of media, for example audio or video), an encoder or streamer is provided at the transmitting terminal. In order to input video content via a cellular telephone, the cellular telephone must have a video camera and an encoder chip such as the ones currently being produced by the company EMBLAZE Systems Ltd. 1 Corazin Street, Givatayim, Israel 53583. The encoder encodes the media into a format that can be translated e.g. MPEG4 for video media. Then the file is sent by a standard FTP method to the MMS server 50 (FTP stands for File Transfer Protocol). Such FTP runs over a TCP/IP protocol.

At the receiving terminal (i.e. at the server 50), an FTP client and a decoder are provided to decode the transmitted file in order to read the file. The decoder allows the receiving terminal to “understand” the encoded data such as the compression, the coded bits, etc. This can be performed by any one of many well known commercially available means such as a Windows Media Player (provided by Microsoft) or Real Player (provided by Real Networks). Also, if streaming is employed, then streaming software is needed at the receiving side, in order to play the media. Streaming software is also well known and commercially available.

Once the information is transferred to the MMS server 50, a dictionary server 30 reads and converts the information into the media type and format type that is requested by the user 10. For example, voice can be recognized by dedicated software and then converted into text. For example, the software called Tel@GO produced by Comverse Networks Systems, Inc., Wakefield, Mass., recognizes voice and converts it into text. Another media conversion type is text to speech conversion. In such conversion, text is read by commercially available software such as the software used by Samsung Telecommunications America, Inc., 1130 E. Arapaho, Richardson, TEX. 75081,.in their voices activated CDMA mobile telephones.

The dictionary server 30 uses protocols as the UAPROF protocol at WAP 2.1 that enables WAP gateways to understand terminal capabilities. WAP stands for Wireless Application Protocol. This protocol enables a device to deliver content from the Internet to a low capability mobile telephones. UAPROF is a sub protocol of the WAP protocol that enables the MMS server 50 to determine the capabilities of the handset that is about to receive the information, before actually sending any information. In such a way, the server 50 can adapt the format of the information that is to be sent, to the capabilities of the handset. WAP protocols are defined and standardized at the WAP forum at www.Wapforum.org. If more than one media type is to be outputted, a synchronization is needed between the various media types. In such a case, synchronization can be achieved by using, for example, SMIL protocol.

If the user 10 requests that the inputted information be translated into a different language, then the translation from one language to another is performed by the dictionary server 30. The dictionary server 30 has a multi-lingual dictionary module that can translate a word in a certain language to a word in another language. It works as a normal commercially available electronic dictionary. However, the present invention possesses a recognition module that can recognize objects from a picture or video stream and also recognize a spoken word from an audio stream. The recognition module in the dictionary server 30 identifies objects in a media and each identified object is given a tag that is, for example, an English word that represents the object. For example, if in a video media stream there were four objects: one tree, two men and one table identified, then the media stream will be given the following tag combination: tree, man, man, table. Now another module will ask the user 10 which object in the stream the user 10 is interested in. This is done by sending the user a marked-up media and asking the user which object the user is interested in. For example, if the inputted media is a video stream, then the objects are marked within the video stream with numbers and the user 10 is requested by the dictionary server 30 to enter the number/s that the user 10 is interested in.

If it is an audio stream, the user 10 can input the language of the audio stream. This can be done before or after the audio steam is input into the system. Additionally, the user's handset allows the user 10 to define the default operating language, the dictionary target language and the input languages for the dictionary. If the audio steam is in one of the languages defined in the user's handset, then the user 10 does not have to tell the dictionary server 30 what language the input language is. Once the system recognizes the words of the audio stream, the dictionary server 30 then displays, after each recognized word, an additional word that represents a number in user's language will be inserted. The user 10 is prompted to choose (key in) the number(s) that he is interested in. However, provided that the number of objects does not exceed a maximum number determined by the processing capabilities of the user's handset, the system could provide translations or identifications of all words/objects.

When the dictionary server 30 knows which objects the user 10 is interested in, the tags (English word describing the object) that were given to those corresponding objects are read by the dictionary server 30 and translated to the requested language (i.e. the English word for “table” is translated into the French word for “table”). The translation (the French word for “table”) can then be encoded into the requested media and format. For example, if the user 10 (assuming the user 10 is English speaking) wanted to know how to pronounce the French word for “table” which was the object chosen from the inputted video (from the example above), then the dictionary server 30 uses the text-to-speech software to transcode the French word for “table” (text media) into the spoken French word for “table” (audio media). Then, the spoken French word for “table” can be encoded into any particular audio format that the user 10 requests (i.e. MP3 format).

Once the information has been translated, transcoded and/or encoded according to the user's request by the dictionary server 30, it is then outputted to the user 10 in the media and format type requested by the user 10. The inputted information is stored in the user's storage space 60 in the same media and format as it is inputted, to allow the user 10 to access the information at a later time. The user 10 then receives this information on the user's mobile handset 20. The user 10 may, in other embodiments of the present invention, receive this information on a personal computer or a fixed telephone line device. Additionally, the user 10 is not limited to receiving the information at the same place or device from which the user 10 requested the translated information. For example, the user 10 may input text into the present invention using a mobile handset 20 but may request that the translated text be outputted to the user's personal computer as an email or be sent as a fax to a particular fax machine. In one embodiment, there is a welcome screen that the user 10 views when entering the services mentioned in this description. By using this screen, the user 10 can specify the particular output device or whether the user 10 would like to access a previously inputted information that is stored in the user's storage space 60. While the default is receiving information at the same terminal that inputted information, it is also possible to provide the outputted information at a different terminal (e.g. an email to a computer or telephone number of another mobile telephone that will receive the output from the dictionary server or a fax machine) using at least one of the aforementioned commercially available transcoding software.

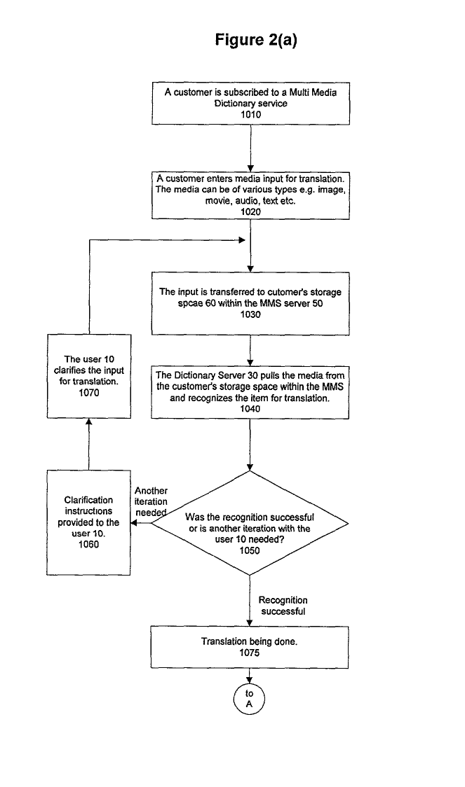

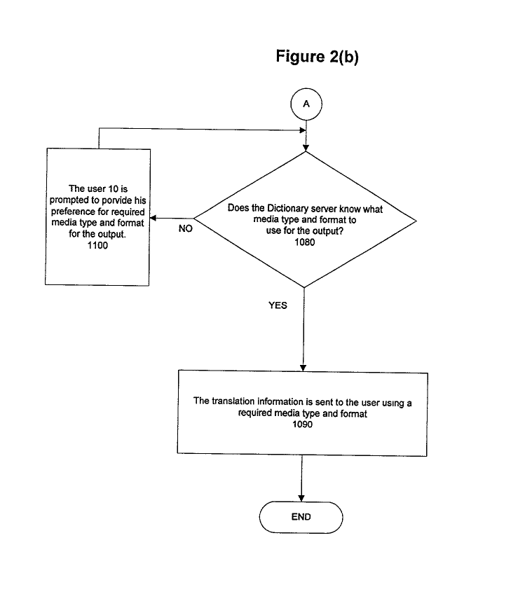

Referring to FIGS. 2(a) and 2(b), the process of a preferred embodiment of the present invention is discussed although this process should not be considered as limiting the present invention. A user 10 accesses the multimedia dictionary service of the present invention using his mobile handset 20 or other device at operation 1010. Once the user 10 accesses the multimedia dictionary service, the user 10 inputs or enters information to be translated in any format at operation 1020. However, in another embodiment of the present invention, the user 10 can access previously translated information that is being stored in the user's storage space 60 as an alternative to inputting new information. In this embodiment, the user 10 is given this option at the time the user 10 access the multimedia system.

The inputted information is then transferred to the user's storage space 60 within the MMS server 50 (FIG. 1) at operation 1030. The user's storage space 60 within the MMS server 50 stores the inputted information for an indefinite amount of time which allows a user 10 to subsequently access the inputted information and perhaps have it translated into a different language or media or both. The server 30 and the MMS 50 exchange two kinds of information or messages: the information itself and a notification of the storage of the information. The notification is responsible for notifying the server 30 of the information in space 60. For example, a picture is stored at the user's storage place (60) within the MMS 50. This picture is in JPEG format. The MMS 50 notifies the server 30 that a picture in JPEG format is stored and it occupies 2K bytes of memory. Therefore, one possible information exchange would be the detail about the picture (i.e. the media type, format, memory size) and the other type of information exchange is the exchange of the picture itself.

The dictionary server 30 then accesses the inputted information from the user's storage space 60 and recognizes the item for translation at operation 1040. In a preferred embodiment, the user 10 inputs the number of objects in a picture, if known. This can make the translation quicker and more accurate by focussing the translation routine. The dictionary server 30 must then decide whether the inputted information is successfully recognized at operation 1050. Inputted information is considered successfully recognized when 1) the recognition software recognizes the objects in a picture or video and 2) the dictionary server 30 determines which object the user 10 is interested in translating. If the inputted information is not successfully recognized by the dictionary server 30, then the user 10 is prompted with clarification instructions at operation 1060. For example, if the inputted information was a picture containing a tree and a man standing next to the tree, the dictionary server 30 may not know which object (the man or the tree) to translate and therefore may request clarification from the user 10 (e.g. “the left or right side object for translation” or “object #1 or #2”). Alternatively, the server 50 can provide two translations, one for the tree and one for the man, and ask the user 10 to select between the two translations in either a text or a speech format.

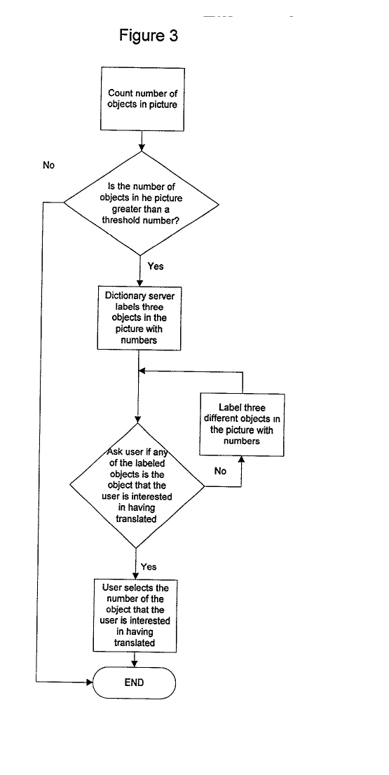

Also, if a user 10 entered a word in a text mode, but with a spelling mistake, the dictionary server 30 will prompt the user 10 to choose from a list of a suggested words that are spelled in a way to resemble the original word, as is done in the spell check routine of Microsoft Word. Further, if the picture has too many details to identify (i.e. if the image recognition software recognizes more objects than a predefined limit), the dictionary server 30 may prompt the user 10 that there are too many items in the picture for translation, and then proceed with a routine to narrow the translation. An example of a routine to narrow the translation is provided in FIG. 3.

As shown in FIG. 3, the object recognition software determines if the number of objects within a picture is above a threshold number. If the number of objects in the picture is not above the threshold number, the user 10 selects which object he is interested in as described above. However, if the number of objects exceeds the threshold number, then the dictionary server 30 labels three objects and asks the user 10 if any of the labeled objects is the one that the user 10 is interested in having translated. If one of the labeled objects is the object that the user 10 is interested in having translated, then the user 10 simply chooses the number of the desired object. However, if none of the labeled objects is the object that the user 10 is interested in having translated, then the dictionary server 30 labels three different objects in the picture and asks the user 10 if any of the newly labeled objects is the one that the user 10 is interested in having translated. This process continues until the object that the user 10 is interested in having translated is labeled and chosen. The threshold number can be any number and the number of objects labeled in each cycle of the routine does not have to be three but can be any number.

In another example, if the quality of voice input is too poor for translation, the dictionary server 30 may prompt the user 10 that the voice was unrecognizable and then request the voice to be re-inputted.

Upon receiving the clarification instructions, the user 10 clarifies the inputted information in the manner requested at operation 1070. For example, the user 10 inputs a picture which contains numerous objects and asks the dictionary server 30 to translate into words an object in the picture. The dictionary server 30 must use an image recognition module to recognize the objects in the picture. For example, surveillance software employed by several law enforcement agencies often use image recognition modules to identify criminals or suspects based on a picture taken and/or with finger prints. Such image recognition modules are commercially available such as the Visionary software sold by MATE-Media Access Technologies, Ltd. and has been standardized in MPEG7. Additionally, there are many robotic image recognition modules used in industry to identify mechanical parts. However, if the image recognition module is unable to discern which object the user 10 needs translated, then a request for clarification or further instructions may be prompted to the user 10 to help determine which object the user 10 needs translated.

If the user 10 is prompted to input additional information to help clarify the translation request, this new information is inputted into the user's storage space 60 within the MMS server 50. The dictionary server 30 then attempts to perform the translation based on the newly inputted clarification information. This process continues until the dictionary server has successfully recognized the inputted information.

Once the dictionary server 30 has successfully recognized the inputted information, the requested translation is performed at operation 1075. Upon translation of the inputted information, the dictionary server 30 then decides whether or not the media type and format of the outputted information has been inputted by the user 10 at operation 1080. If the dictionary server 30 does not know what media type and format the user 10 wishes to have outputted, then server 30 prompts the user 10 to provide his preference for the required media type and format to be outputted at operation 1100. Finally, once the dictionary server 30 receives the media type and format to be outputted, the translated information is sent to the user 10 in the requested media type and format at operation 1090.

As an illustrative example, Bob is in Japan. He asks for directions to the hotel from a Japanese gentleman. While receiving the directions in Japanese, he hears a word that he does not understand, but knows that it is an important word in the directions. Bob politely asks the Japanese gentleman to pronounce the word into his handset. Then, Bob sends the word to the dictionary server 30. Bob then inputs into his handset that the sent word is in Japanese. The dictionary server translates the word and then prompts Bob as to what format he would like to receive the translations. Bob inputs into his handset that he would like to receive the word in English text. The dictionary server 30 then outputs the word as English text and the word is displayed in English on Bob's handset.

Although the above describes a preferred embodiment, other embodiments are also available. For example, in another embodiment of the present invention, the user 10 may enter the preferred output format and media type prior to entering the inputted information instead of entering the preferred output after entering the inputted information. In another embodiment, an additional storage server may be added enabling a user 10 to maintain a history of all the translations that he has requested. An additional server may become necessary because media files are often quite large and if history is needed, it will bring the system to different sizing requirements. Thus, additional server may be added in order to provide the capability to cope with all storage space that will be needed. Furthermore, the dictionary server may use any newly developed protocol for recognition of different types of media. The protocols and media types that are currently available are specified in standard 23.140 of 3GPP at www.3gpp.org, incorporated herein by reference.

What is claimed is:

1. A multimedia dictionary system comprising:
an MMS server operable to recognize and translate inputted media information inputted by a user;
wherein the user inputs information into the MMS server which recognizes the inputted information and translates the inputted information into a different at least one of language, format and media type.

2. The multimedia dictionary system of claim 1, wherein the MMS server stores the inputted media information.

3. The multimedia dictionary system of claim 1, wherein the MMS server translates the inputted information into a different at least one of language, format and media type specified by the user.

4. The multimedia dictionary system of claim 1, wherein the MMS server further comprises a user storage space allocated for the inputted information of a particular user.

5. The multimedia dictionary system of claim 1, wherein the user inputs the inputted information using a cellular telephone.

6. The multimedia dictionary system of claim 1, wherein the user inputs the inputted information using a personal computer.

7. The multimedia dictionary system of claim 1, wherein the user inputs the inputted information using a fixed telephone line device.

8. The multimedia dictionary system of claim 1, wherein the user inputs the inputted information in at least one of the following media types: video, audio and text.

9. The multimedia dictionary system of claim 8, wherein the MMS server translates and outputs translated information in a different language than the inputted information.

10. The multimedia dictionary system of claim 8, wherein the MMS server outputs information in a different form than the inputted information.

11. The multimedia dictionary system of claim 8, wherein the MMS server outputs information to a different terminal than the terminal from which the information was inputted.

12. The multimedia dictionary system of claim 8, wherein the MMS server outputs information to a same terminal from which the information was inputted.

13. The multimedia dictionary system of claim 8, wherein the MMS server outputs information in a same form from which the information was inputted.

14. The multimedia dictionary system of claim 8, wherein the inputted information is a video file for translation into a text file.

15. The multimedia dictionary system of claim 8, wherein the inputted information is a video file for translation into a voice file.

16. The multimedia dictionary system of claim 8, wherein the inputted information is voice of one language for translation to another different language.

17. The multimedia dictionary system of claim 8, wherein the inputted information is voice for translation to text.

18. The multimedia dictionary system of claim 8, wherein the inputted information is an object file for translation to text.

19. The multimedia dictionary system of claim 8, wherein the inputted information is an object file for translation to voice.

20. The multimedia dictionary system of claim 8, wherein the user inputs information with a mobile telephone and translated information is outputted as an email message.

21. The multimedia dictionary system of claim 8, wherein the user inputs information with a mobile telephone and translated information is outputted to a fax machine.

22. The multimedia dictionary system of claim 8, wherein the user inputs information with a mobile telephone and translated information is outputted to another different mobile telephone.

23. The multimedia dictionary system of claim 8, wherein the inputted information is an object for translation to text.

24. The multimedia dictionary system of claim 8, wherein the inputted information is an object for translation to voice.

25. The multimedia dictionary system of claim 8, wherein the MMS server contains object recognition software.

26. The multimedia dictionary system of claim 8, further comprising an additional dictionary server, wherein the dictionary server performs translation of inputted information and the MMS server stores translated information as an MMS message.

27. A method of translating information comprising:
inputting information to a remote MMS server from a terminal by a user;
translating the inputted information into a different at least one of language, format and media; and
outputting the translated information.

28. The method of translating information of claim 27, further comprising:
determining whether the remote MMS server recognizes the inputted information; and
prompting a user for clarification information until the inputted information is recognized by the remote MMS server.

29. The method of translating information of claim 27, wherein the translating is performed according to the user's instruction.

30. The method of translating information of claim 27, further comprising:
storing translated information within an allocated user storage space.

31. The method of translating information of claim 27, wherein the inputted information is inputted using a cellular telephone.

32. The method of translating information of claim 27, wherein the inputted information is inputted using a personal computer.

33. The method of translating information of claim 27, wherein the inputted information is inputted using a fixed telephone line device.

34. The method of translating information of claim 27, wherein the inputted information is in at least one of the following media types: video, audio and text.

35. The multimedia dictionary system of claim 34, wherein the remote MMS server outputs translated information in a different language than the inputted information.

36. The multimedia dictionary system of claim 34, wherein the remote MMS server outputs information in a different form than the inputted information.

37. The multimedia dictionary system of claim 34, wherein the remote MMS server outputs information to a different terminal than the terminal from which the information was inputted.

38. The multimedia dictionary system of claim 34, wherein the remote MMS server outputs information to a same terminal from which the information was inputted.

39. The multimedia dictionary system of claim 34, wherein the remote MMS server outputs information in a same form from which the information was inputted.

40. The multimedia dictionary system of claim 34, wherein the inputted information is a video file for translation into a text file.

41. The multimedia dictionary system of claim 34, wherein the inputted information is a video file for translation into a voice file.

42. The multimedia dictionary system of claim 34, wherein the inputted information is voice of one language for translation to another different language.

43. The multimedia dictionary system of claim 34, wherein the inputted information is voice for translation to text.

44. The multimedia dictionary system of claim 34, wherein the inputted information is an object file for translation to text.

45. The multimedia dictionary system of claim 34, wherein the inputted information is an object file for translation to voice.

46. The multimedia dictionary system of claim 34, wherein the user inputs information with a mobile telephone and translated information is outputted to an email.

47. The multimedia dictionary system of claim 34, wherein the user inputs information with a mobile telephone and translated information is outputted to a fax.

48. The multimedia dictionary system of claim 34, wherein the user inputs information with a mobile telephone and translated information is outputted to another different mobile telephone.

49. The multimedia dictionary system of claim 34, wherein the inputted information is an object for translation to text.

50. The multimedia dictionary system of claim 34, wherein the inputted information is an object for translation to voice.

51. The multimedia dictionary system of claim 34, wherein the remote MMS server contains object recognition software.

52. The multimedia dictionary system of claim 35, wherein the translating is performed by an additional dictionary server and the outputting of the translated information is performed by the remote MMS server.
